(19) United States
(12) Patent Application Publication
(10) Pub. No.: US 2022/0147380 A1
(43) Pub. Date: May 12, 2022

(54) Optimizing Hybrid Cloud Usage

(71) Applicant: Dell Products, L.P., Round Rock, TX (US)

(72) Inventors: Nadav Azaria, Beer Sheva (IL); Amihai Savir, Sansana (IL); Itay Azaria, Dimona (IL); Avitan Gefen, Tel Aviv (IL)

(21) Appl. No.: 17/095,307

(22) Filed: Nov. 11, 2020

(51) Int. Cl. G06F 9/455; G06F 9/50

(52) U.S. Cl. CPC G06F 9/45558; G06F 9/505; G06F 2009/45562; G06F 2009/45583; G06F 2009/4557

(57) ABSTRACT

Techniques are provided for optimizing hybrid cloud usage. In an example, a cloud spot manager can manage spot virtual machine instances for on-premises systems for multiple different customers. Where a customer requires more resources on its system, the cloud spot manager can terminate another customer's spot virtual machine on that system. Where a customer needs more resources than can be provided by its system, the cloud spot manager can determine another customer system to locate the first customer's spot virtual machine, and instantiate that virtual machine there.

### TECHNICAL FIELD

The present application relates generally to cloud computing, which can generally be computer systems that provide access to computing resources on-demand and via a public computer communications network, such as the INTERNET.

### BACKGROUND

Cloud computing models are changing. A cloud is no longer a destination, but rather now can be an operating model. In this paradigm, resource provider customers can order hardware and software that will be located on their physical premises, and pay for it in a monthly subscription model, while receiving a cloud-like experience.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate optimizing hybrid cloud usage, in accordance with certain embodiments of this disclosure;

FIG. 2 illustrates another example system architecture that can facilitate optimizing hybrid cloud usage, in accordance with certain embodiments of this disclosure;

FIG. 3 illustrates an example process flow for deploying a spot virtual machine (VM) to facilitate optimizing hybrid cloud usage, in accordance with certain embodiments of this disclosure;

FIG. 4 illustrates an example process flow for reporting resource metrics to a cloud spot manager, in accordance with certain embodiments of this disclosure;

FIG. 5 illustrates an example process flow for forecasting resource usage, in accordance with certain embodiments of this disclosure;

FIG. 6 illustrates an example graph for forecasting resource usage to facilitate optimizing hybrid cloud usage, in accordance with certain embodiments of this disclosure;

FIG. 7 illustrates an example process flow for terminating a VM to facilitate optimizing hybrid cloud usage, in accordance with certain embodiments of this disclosure;

FIG. 8 illustrates an example process flow for deploying a customer VM remotely where a customer has exhausted local resources to facilitate optimizing hybrid cloud usage, in accordance with certain embodiments of this disclosure;

FIG. 9 illustrates an example process flow for determining client billing to facilitate optimizing hybrid cloud usage, in accordance with certain embodiments of this disclosure;

FIG. 10 illustrates an example process flow to facilitate optimizing hybrid cloud usage, in accordance with certain embodiments of this disclosure; and

FIG. 11 illustrates an example block diagram of a computer operable to execute certain embodiments of this disclosure.

### DETAILED DESCRIPTION

### Overview

A cloud provider can generally be a company that offers a cloud-based computing platform, infrastructure, application, or storage services. In some examples, some computer hardware associated with a cloud provider can be located at a customer's physical site, on-premises. A resource provider customer can generally be a cloud customer that makes available unused computing resources to cloud computing operations. A resource consumer customer can generally be a cloud customer that consumes computing resources from a resource provider customer. A customer's role as a resource provider customer or a resource consumer customer

In examples where customers subscribe to hardware located on their site, a goal can be to lower a customer's cost to approach, meet, or beat a cost associated with using public cloud resources.

In a public cloud, resource providing customers can pay exactly for the computing resources they consume. In contrast, in some examples of an on-premises hardware subscription model, resource providing customers can need to commit to a minimum hardware capacity of the subscription (e.g., what hardware is physically installed on-premises), and a minimum length of time of the subscription (e.g., 12 months).

According to the present techniques, a resource providing customer can take advantage of its unused computing resources. These unused computing resources can be used by a cloud provider in an interruptible manner (i.e., those unused computing resources can be made available to the resource providing customer at the moment that the resource providing customer needs them). A system according to the present techniques can use a data-driven approach to predict resource consumption and help minimize interrupt events where a cloud provider will kill its VMs and return on-premises computing resources to the resource providing customer.

A customer that leases on-premises hardware can need to supply only a suitable location with electricity, and a computing network. With little effort, the customer can extend its subscription and/or lease more hardware.

In some examples, a goal of a cloud service can be to provide fast deployment of resources, scalability, strong security, observability, intelligence around workload management, cost management, and elasticity.

In some public clouds, customers pay for only the computing resources they use. The granularity is optimal. For example, if a public cloud user spins up an instance for 2 minutes and 3 seconds, then the user will be charged for 2 minutes and 3 seconds of usage time.

In some examples according to the present techniques, a resource producing customer also pays for what it uses. A difference can be in granularity—from a granularity of seconds in a public cloud to a granularity of years. For example, a minimum commitment that a customer can make can be for 3 nodes for 12 months. A customer can then pay for that monthly even if the customer uses only a fraction of those computing resources. Then, according to the present techniques, a resource producing customer can have a pricing model that approaches that of a public cloud.

In some examples, a resource producing customer can take advantage of local unused resource capacity. A system can allow a cloud provider to utilize unused resource producing customer computing resources by running external VMs on the customer's leased computing hardware in an interruptible mode. This can mean that, in an event where a resource providing customer needs more resources that might be used by the cloud provider (where the cloud provider can mediate between resource providing customers and resource consumer customers), the cloud provider can free those computing resources immediately. Such a system can strive to minimize such resource-freeing events (because they can correspond to terminating a resource consumer customer's virtual machine in the middle of performing a task) by using a data-driven approach for predicting resource consumption. That is, a cloud provider can utilize unused resources that the cloud provider determines are likely to have a low, or lowest, probability of being needed by the respective resource producing customer.

A system according to the present techniques can generally comprise a VM spot manager and a cloud spot manager. A spot VM (sometimes referred to as a spot VM instance) can be a VM that operates without any guarantee of a time for which is will operate. It can be terminated at any time to free resources for another task. Then, where there is a charge associated with running VMs, a charge for running a spot VM can be less than a charge for running a non-spot VM.

A VM spot manager can itself be a VM that runs on a resource providing customer's hardware. A VM spot manager can connect to a cloud spot manager and allow the cloud spot manager to deploy resource consumer customer VMs on available computing resources of a resource producing customer's hardware. A VM spot manager can also monitor resource utilization of the local resource producing customer's VMs to report back usage statistics to the cloud spot manager, and to kill resource consumer customer VMs if the resource producing customer needs more resources.

The cloud spot manager can run in the cloud and can communicate with multiple VM spot mangers to monitor resource utilization of the VM spot managers' respective hardware, and to create resource consumer customer VMs. The cloud spot manager can determine which resource producing customer's hardware is suitable for running new resource consumer customer VMs, such as by forecasting or predicting future resource utilization by the resource producing customers (to mitigate against needing to kill a resource consumer customer VM because the resource producing customer needs the associated computing resources).

Resource consumer customer VMs can be run in a dedicated resource pool (which can be referred to as a resource consumer customer resource pool). A VM spot manager can have an associated user account defined for the customer's leased hardware. This user account can be assigned a read role for resource pools, including implicit resource pools like a host resource pool and a remote desktop services cluster resource pool. This role can be used for the purpose of collecting resource utilization information, such as resource utilization key performance indicators (KPIs). The user account can also be assigned an administrator account for a resource pool.

A VM spot manager can also have a dedicated wide area network (WAN), which can be used to connect resource consumer customer VMs and the VM spot manager with the cloud spot manager. This network can be monitored for bandwidth utilization, and the customer can be credited or compensated for bandwidth on this network that is used.

A cloud spot manager can comprise an artificial intelligence component. This artificial intelligence component can collect data to use in a data-driven approach for recommending a location for new resource consumer customer VMs to be placed. The artificial intelligence component can collect information of all available resource locations (e.g., resource provider customer leased hardware). This collected information can include KPIs such as processor utilization, memory, storage, network, etc. These KPIs can be expressed in terms of relative load—i.e., an amount of total processing resources that are being used. Additionally, this collected information can include potential resource capacities in the future. This information can be collected on-premises and sent to the cloud spot manager.

The artificial intelligence component can process this collected data into a multivariate time series, per resource provider customer location.

The artificial intelligence (AI) component can then make determinations based on historical multivariate time-series data. The AI component can develop a resource load score (RLS) that consolidates multiple KPIs into one value. In different examples, several approaches to determining a RLS can be used. An example for determining a RLS can be:

RLS−Max(L(i))

where i is a metric in a set of KPIs, and L(i) is the load of the metric i.

Another example of determining RLS can be:

RLS=Sum(wᵢ*L(i))

where wᵢ is a weight of metric i.

A historical times-series for a RLS can be utilized with a forecasting technique, a regression model, or other techniques to forecast near future behavior of a particular resource provider customer system. Factors that can be considered in this forecasting can include seasonality, a day of the week, an hour of the day, holidays and more.

Based on this information, the AI component can recommend a location to place a resource consumer customer VM instance. The cloud spot manager can periodically (e.g., every few minutes) produce a forecast of a future load utilization of all resource provider customer systems in the cloud for one or more time windows. When a resource consumer customer requests placing a VM instance on a resource provider customer system, the cloud spot manager can choose a resource provider customer location that has a lowest forecasted load. A second sorting by the AI component can also consider resource capacities of each resource provider customer system.

An on-premises cloud computing solution can provide for a flexible pricing model that is subscription based. According to the present techniques, elasticity of the computing resources can be provided, including peak hours, off peak hours, and average consumption. To provide both a cloud-type pricing model and cloud-type resource elasticity, customers can have more compute power on their peak hours by leveraging another's on-premises system, and customers can save on the cost of their on-premises system by exposing resources when they are not leveraging them. According to the present techniques, both resource provider customers and resource consumer customers can benefit from accessing cloud advantages at an improved price.

That is, on-premises resources can be dynamically repurposed by learning their usage patterns. On-premises models for resource repurposing can be automated according to a resource provider customer's usage patterns and custom engineered features. On-premises models for resource repurposing can include a VM spot manager sharing a summary of usage patterns with a cloud spot manager. This information can be leveraged by a cloud spot manager for load handling by a recommender system that forecasts future resource utilization of various resource provider customers.

### Example Architectures

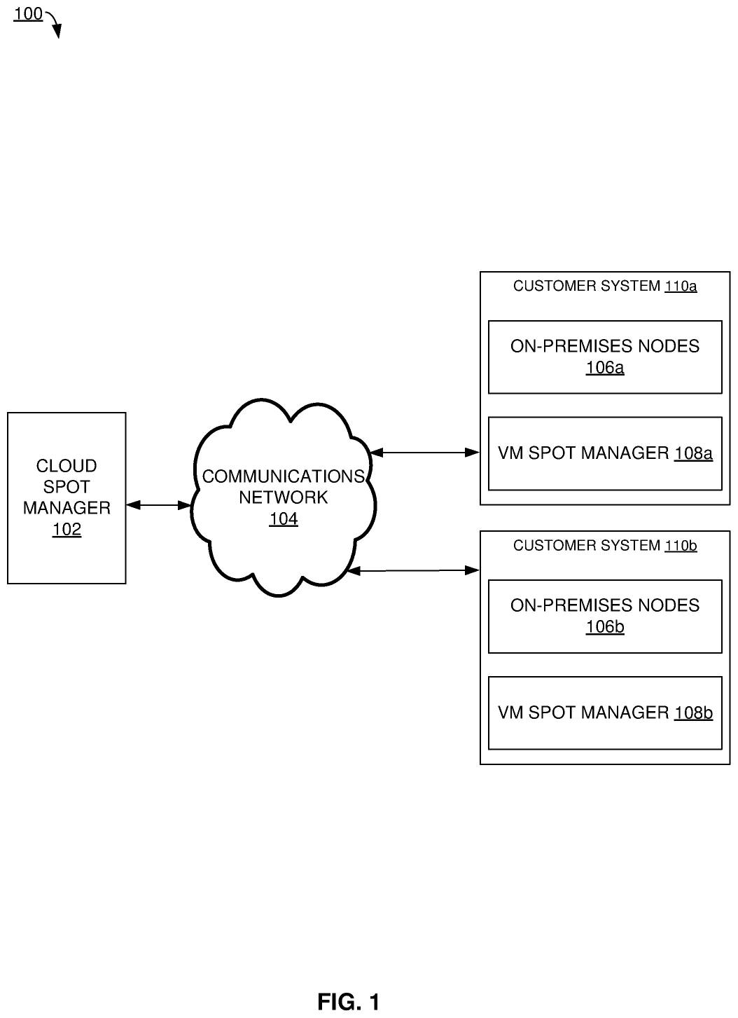

FIG. 1 illustrates an example system architecture 100 that can facilitate optimizing hybrid cloud usage, in accordance with certain embodiments of this disclosure. As depicted, system architecture 100 comprises cloud spot manager 102, communications network 104, customer system 110a, and customer system 110b. In turn, customer system 110a comprises on-premises nodes 106a and VM spot manager 108a. Likewise, customer system 110b comprises on-premises nodes 106b and VM spot manager 108b.

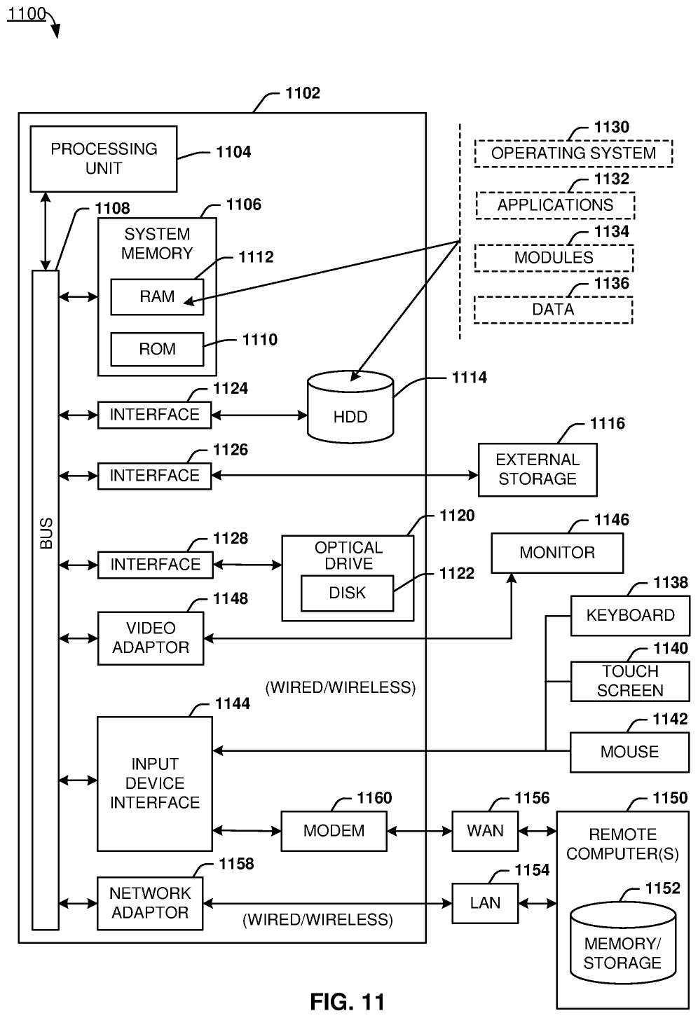

Each of cloud spot manager, on-premises nodes 106a, on-premises nodes 106b, customer system 110a, and customer system 110b can be implemented with one or more instances of computer 1102 of FIG. 11. In some examples, each of VM spot manager 108a and VM spot manager 108b can be implemented with machine-executable instructions and/or aspects of computer 1102 of FIG. 11.

Communications network 104 can comprise a computer communications network, such as the INTERNET, or an isolated private computer communications network. Cloud spot manager 102 can communicate with each of customer system 110a and customer system 110b via communications network 104.

On-premises nodes 106a and on-premises nodes 106b can comprise computer hardware upon which one or more VMs can be executed.

A VM spot manager (e.g., VM spot manager 108a or VM spot manager 108b) can itself be a VM that runs on a resource providing customer's hardware. A VM spot manager can connect to cloud spot manager 102 and allow cloud spot manager 102 to deploy resource consumer customer VMs on available computing resources of a resource producing customer's hardware. A VM spot manager can also monitor resource utilization of the local resource producing customer's VMs to report back usage statistics to cloud spot manager 102, and to kill resource consumer customer VMs if the resource producing customer needs more resources.

Cloud spot manager 102 can run in the cloud and can communicate with multiple VM spot mangers to monitor resource utilization of the VM spot managers' respective hardware, and to create resource consumer customer VMs. Cloud spot manager 102 can determine which resource producing customer's hardware is suitable for running new resource consumer customer VMs, such as by forecasting or predicting future resource utilization by the resource producing customers (to mitigate against needing to kill a resource consumer customer VM because the resource producing customer needs the associated computing resources).

It can be appreciated that there can be system architectures that comprise more VM spot managers than the two VM spot managers (VM spot manager 108a and VM spot manager 108b) depicted in system architecture 100.

Over time, different customer systems can switch between being resource consumer customers and resource provider customers. For example, when customer system 110a is out of resources to deploy a customer VM, customer system 110a can be associated with a resource consumer customer and customer system 110b can be associated with a resource provider customer. Then, during times when customer system 110b is out of resources to deploy a customer VM, customer system 110a can be associated with a resource provider customer and customer system 110b can be associated with a resource consumer customer.

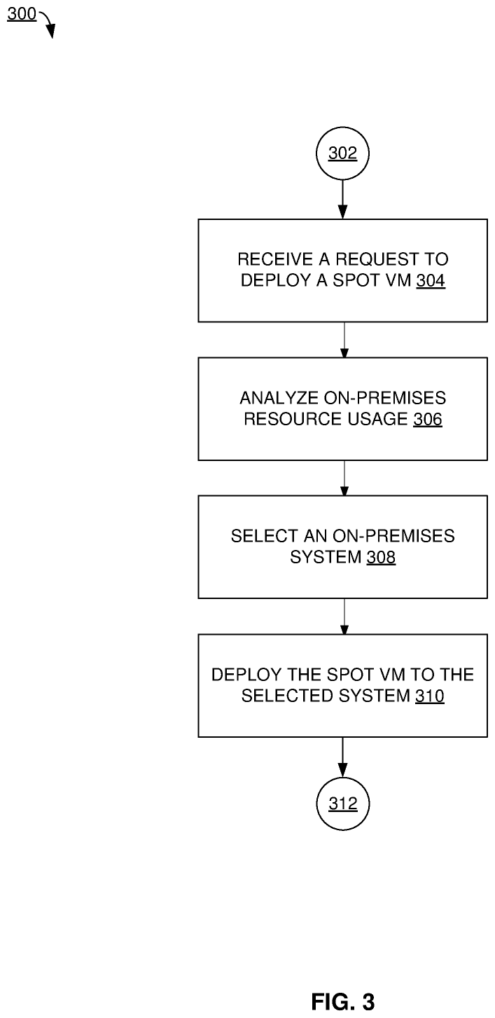

Cloud spot manager 102 can implement aspects of the process flows of FIGS. 3-5 and 7-10 to facilitate optimizing hybrid cloud usage.

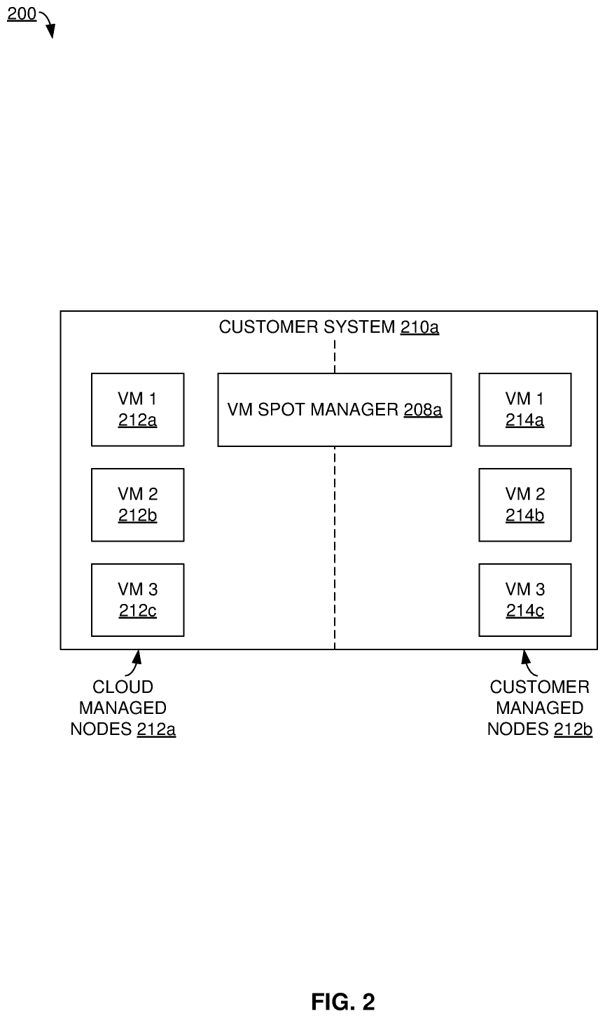

FIG. 2 illustrates another example system architecture 200 that can facilitate optimizing hybrid cloud usage, in accordance with certain embodiments of this disclosure. As depicted, system architecture comprises customer system 210a. In turn, customer system comprises VM spot manager 208a, cloud managed nodes 212a, and customer managed nodes 212b. Cloud managed nodes 212a comprise VM 1 212a, VM 2 212b, and VM 3 212c. Customer managed nodes 212c comprise VM 1 214a, VM 2 214b, and VM 3 212c.

Customer system 210a can be similar to customer system 110a and/or customer system 110b of FIG. 1. VM spot manager 208a can be similar to VM spot manager 108a of FIG. 1.

Cloud managed nodes 216a and customer managed nodes 216b can be similar to on-premises nodes 106a and/or on-premises nodes 106b of FIG. 1. Cloud managed nodes 216a can host VMs—here, VM 1 212a, VM 2 212b, and VM 3 212c. These can be VMs that are owned by the customer that has customer system 210a. They can also be VMs that are placed there and managed by a cloud spot manager on behalf of a resource consumer customer, or a combination of customer VMs and resource consumer customer VMs.

Customer managed nodes 216b can also host VMs—here, VM 1 214a, VM 2 214b, and VM 3 212c. These can all be VMs that are owned by the customer that has customer system 210a. These VMs can be monitored (though not managed) by a cloud spot manager. In some examples, computing resources associated with customer managed nodes 212b are not made available to a resource consumer customer for placement of the resource consumer customer's VMs.

In some examples, cloud spot manager 102 of FIG. 1 interact with system architecture 200, and in doing so, cloud spot manager 102 can implement aspects of the process flows of FIGS. 3-5 and 7-10 to facilitate optimizing hybrid cloud usage.

### Example Process Flows and Graph

FIG. 3 illustrates an example process flow 300 for deploying a spot VM to facilitate optimizing hybrid cloud usage, in accordance with certain embodiments of this disclosure. In some examples, aspects of process flow 300 can be implemented by cloud spot manager 102 of FIG. 1, or computing environment 1100 of FIG. 11.

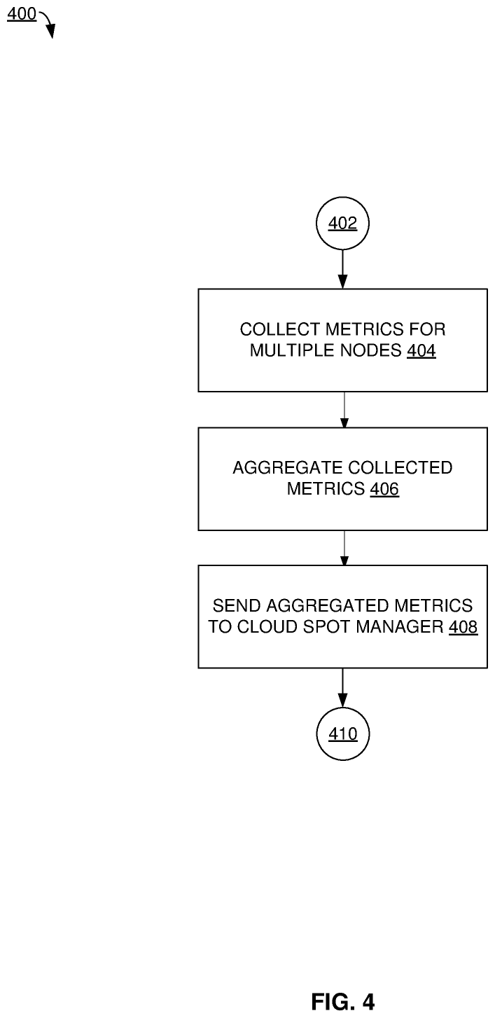

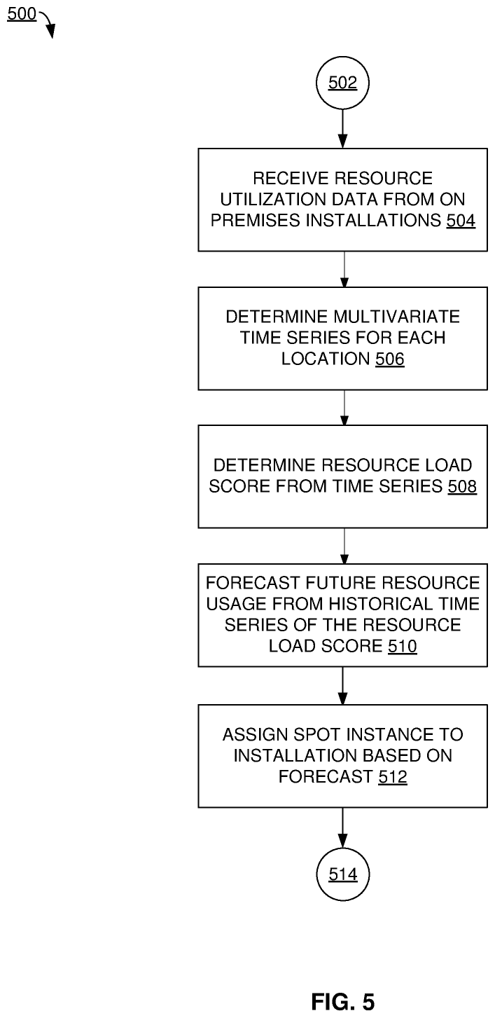

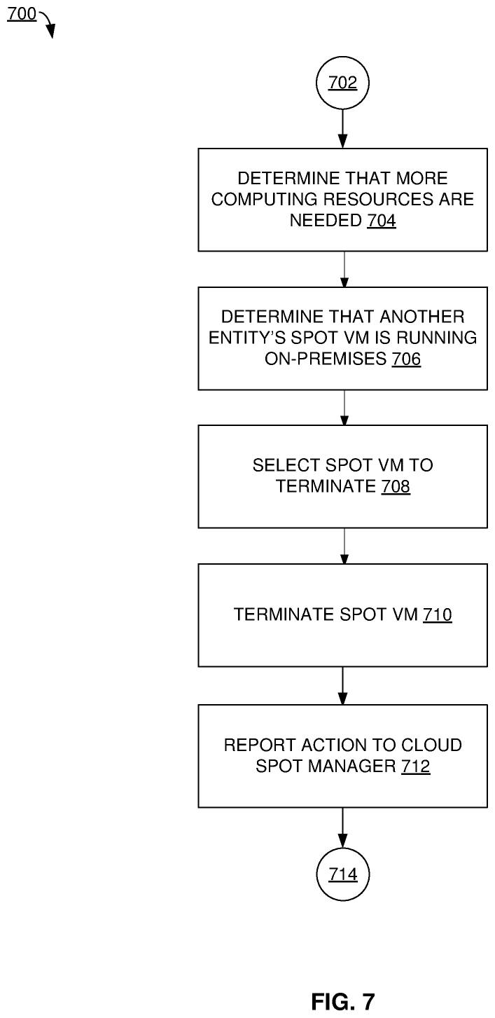

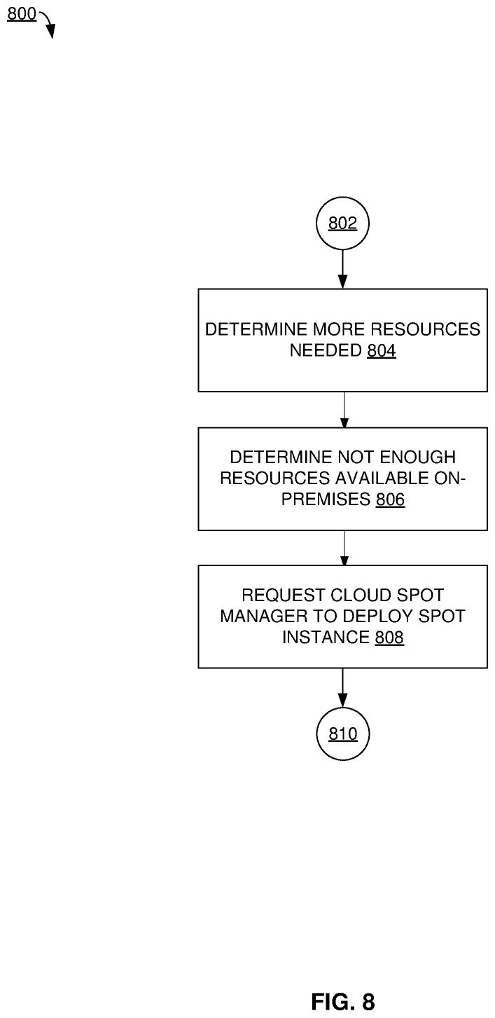

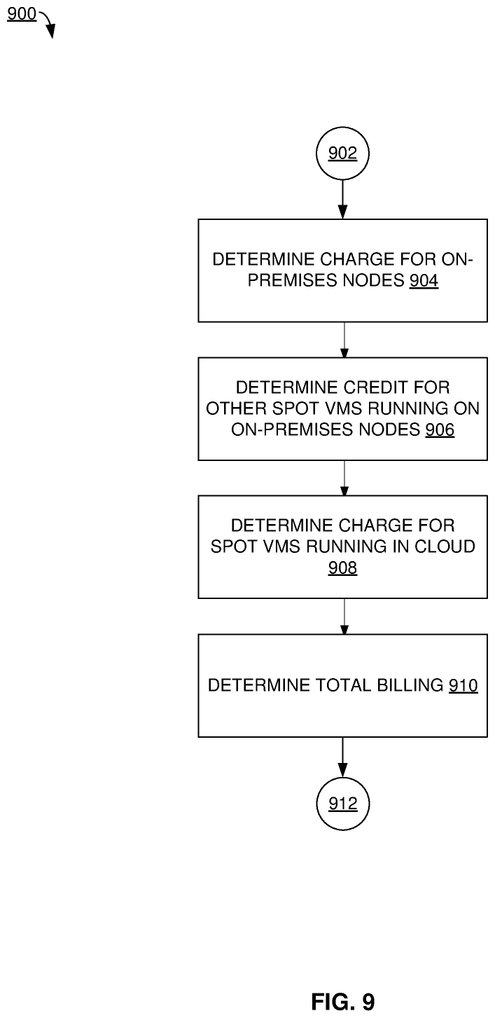

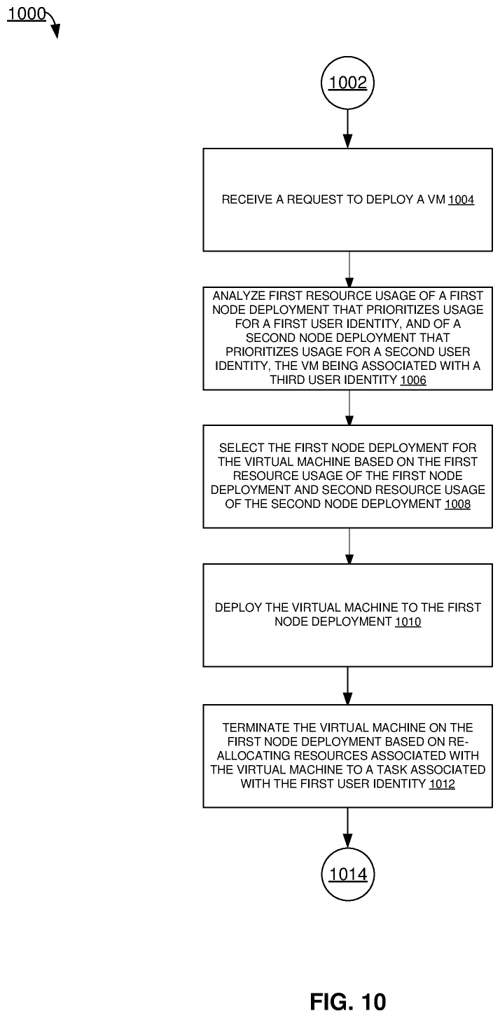

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with aspects of one or more of process flow 400 of FIG. 4, process flow 500 of FIG. 5, process flow 700 of FIG. 7, process flow 800 of FIG. 8, process flow 900 of FIG. 9, and process flow 1000 of FIG. 10.

Process flow 300 begins with 302, and moves to operation 304. Operation 304 depicts receiving a request to deploy a spot VM. Using the example of system architecture 100 of FIG. 1, this can be a request received by cloud spot manager 102 and from VM spot manager 108a of customer system 110a via communications network 104. This request can be to deploy a spot VM somewhere other than on customer system 110a, such as customer system 110b or another customer system. After operation 304, process flow 300 moves to operation 306.

Operation 306 depicts analyzing on premises resource usage. In some examples, VM spot managers can send information about their corresponding on-premises nodes to cloud spot manager 102. For example, VM spot manager 108a can send information about on-premises nodes 106a to cloud spot manager 102. Likewise, VM spot manager 108b can send information about on-premises nodes 106b to cloud spot manager 102. This information can comprise information about a load of the corresponding on-premises nodes.

In some examples, a VM spot manager can send information to cloud spot manager 102 by implementing process flow 400 of FIG. 4. After operation 306, process flow 300 moves to operation 308.

Operation 308 depicts selecting an on-premises system. In some examples, operation 308 can be implemented in a similar manner as process flow 500 of FIG. 5, such as by implementing operations 506-512 of FIG. 5. After operation 308, process flow 300 moves to operation 310.

Operation 310 depicts deploying the spot VM to the selected system. In some examples, operation 310 can comprise cloud spot manager 102 of FIG. 1 instructing the VM spot manager of the selected system (e.g., VM spot manager 108b) to start and run the spot VM on one of the selected system's nodes (e.g., on-premises nodes 106b). After operation 310, process flow 300 moves to 312, where process flow 300 ends.

FIG. 4 illustrates an example process flow 400 for reporting resource metrics to a cloud spot manager, in accordance with certain embodiments of this disclosure. In some examples, aspects of process flow 400 can be implemented by VM spot manager 108a or VM spot manager 108b of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with aspects of one or more of process flow 300 of FIG. 3, process flow 500 of FIG. 5, process flow 700 of FIG. 7, process flow 800 of FIG. 8, process flow 900 of FIG. 9, and process flow 1000 of FIG. 10.

Process flow 400 begins with 402, and moves to operation 404. Operation 404 depicts collecting metrics for multiple nodes. An on-premises system can comprise multiple computing nodes on which VMs can be executed. Each node can run a process that collects system metrics, such as processor usage and memory usage over time. Each node can report these system metrics to the corresponding VM spot manager via the node's process. In some examples, the process can proactively send the metrics to the VM spot manager, and in other examples, the VM spot manager can access an application programming interface (API) exposed by the process to access the metrics gathered by the process. After operation 404, process flow 400 moves to operation 406.

Operation 406 depicts aggregating collected metrics. This can comprise a VM spot manager aggregating metrics for the multiple nodes of an on-premises system that it manages For instance, VM spot manager can combine each node's percentage computer memory usage to come up with a single metric that identifies an overall percentage of computer memory usage of the computer memory across the nodes of the on-premises system. After operation 406, process flow 400 moves to operation 408.

Operation 408 depicts sending aggregated metrics to the cloud spot manager. This can comprise a VM spot manager (e.g., VM spot manager 108a or VM spot manager 108b of FIG. 1) sending the aggregated metrics to cloud spot manager 102 via communications network 104. After operation 408, process flow 400 moves to operation 410, where process flow 400 ends.

FIG. 5 illustrates an example process flow 500 for forecasting resource usage, in accordance with certain embodiments of this disclosure. In some examples, aspects of process flow 500 can be implemented by cloud spot manager 102 (for one or more on-premises systems), VM spot manager 108a, or VM spot manager 108b of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with aspects of one or more of process flow 300 of FIG. 3, process flow 400 of FIG. 4, process flow 700 of FIG. 7, process flow 800 of FIG. 8, process flow 900 of FIG. 9, and process flow 1000 of FIG. 10.

Process flow 500 begins with 502, and moves to operation 504. Operation 504 depicts receiving resource utilization data from on-premises installations. In some examples, operation 504 can be implemented in a similar manner as operation 408 of FIG. 4. Using the example of system architecture 100 of FIG. 1, whereas in operation 408 it can be a VM spot manager (e.g., VM spot manager 108a) that is performing the sending to a cloud spot manager (e.g., cloud spot manager 102), here in operation 504 it can be a cloud spot manager performing the receiving from a VM spot manager. After operation 504, process flow 500 moves to operation 506.

Operation 506 depicts determining a multivariate time series for each location. A multivariate time series can measure how multiple variables (e.g., measurements of computer resource utilization like memory utilization and processor utilization) vary over a period of time. In operation 506, a location can be a customer system, such as customer system 110a of FIG. 1.

In some examples, cloud spot manager 102 of FIG. 1 can collect data from a VM spot manager over time, and associate each part of that collected data with a timestamp (e.g., the time at which the data was received, or the data itself can be timestamped). In such examples, determining the multivariate time series can comprise cloud spot manager 102 collecting and organizing the data that is received from a VM spot manager to form a multivariate time series of the data. After operation 506, process flow 500 moves to operation 508.

Operation 508 depicts determining a resource load score from the time series. In some examples, the resource load score itself can be a time series. A resource load score can combine the multiple data values at a given time point into a single value. For example, when the multiple data values each measure a percentage of utilization for a different computer resource (e.g., memory, processor), the resource load score for a given point in time can be the maximum value among those values for that point in time. After operation 508, process flow 500 moves to operation 510.

Operation 510 forecasting future resource usage from a historical time series of the resource load score. In some examples, operation 510 can comprise implementing a forecasting technique, a regression model, or other techniques to forecast near future behavior of a particular system. Factors that can be considered in this forecasting can include seasonality, a day of the week, an hour of the day, holidays and more. After operation 510, process flow 500 moves to operation 512.

Operation 512 depicts assigning a spot instance to an installation based on the forecast. In some examples, operation 512 can comprise assigning the spot instance to the installation based on forecasting that that installation will have a lowest resource load score of the installations (e.g., customer system 110a and customer system 110b) over a given future time period. After operation 512, process flow 500 moves to 512, where process flow 500 ends.

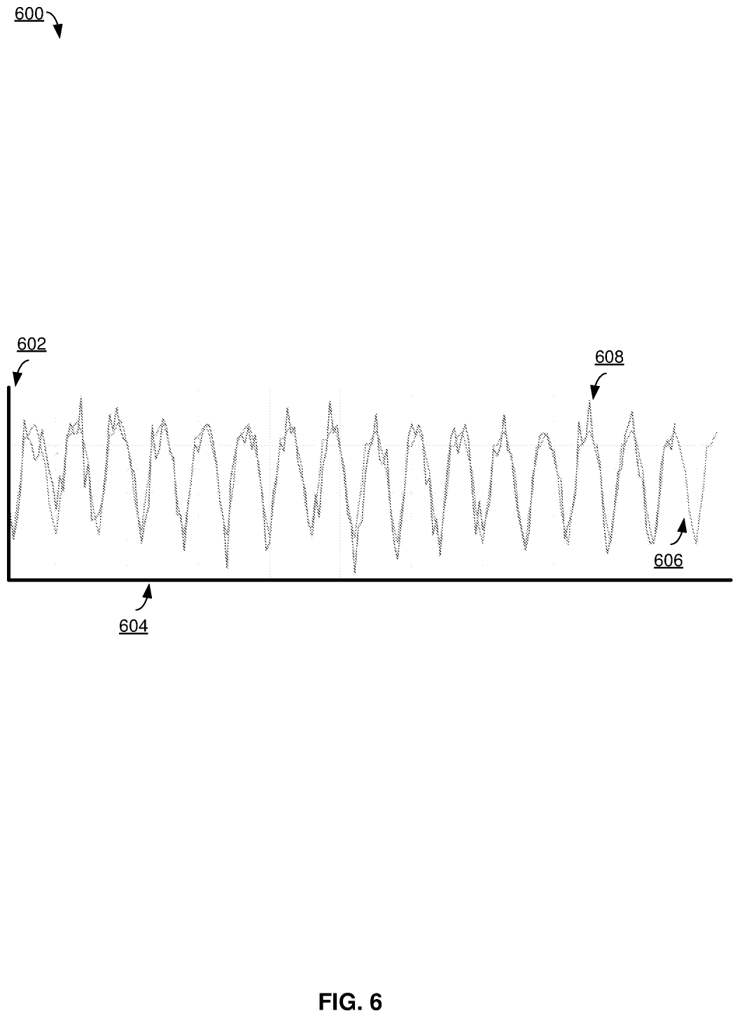

FIG. 6 illustrates an example graph 600 for forecasting resource usage to facilitate optimizing hybrid cloud usage, in accordance with certain embodiments of this disclosure. In some examples, graph 600 can represent the forecast future resource usage of operation 510 of FIG. 5.

Graph 600 comprises Y-axis 602 (which can measure a resource load score value), X-axis 604 (which can measure time), plot 606, and plot 608. Plot 606 can represent a forecast, or predicted, resource load score (such as from operation 510 of FIG. 5), and plot 608 can represent an actual observed and/or determined resource load score over time, from which the forecast of plot 606 is based.

FIG. 7 illustrates an example process flow 700 for terminating a VM to facilitate optimizing hybrid cloud usage, in accordance with certain embodiments of this disclosure. In some examples, aspects of process flow 700 can be implemented by VM spot manager 108a or VM spot manager 108b of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with aspects of one or more of process flow 300 of FIG. 3, process flow 400 of FIG. 4, process flow 500 of FIG. 5, process flow 800 of FIG. 8, process flow 900 of FIG. 9, and process flow 1000 of FIG. 10.

Process flow 700 begins with 702, and moves to operation 704. Operation 704 depicts determining that more computing resources are needed. In some examples, this can comprise VM spot manager 108a of FIG. 1 determining to instantiate another VM instance, and determining that on-premises nodes 106a lack the available computing resources to host this VM instance (or that hosting the VM instance would take node resource usage above a predetermined threshold). After operation 704, process flow 700 moves to operation 706.

Operation 706 depicts determining that another entity's spot VM is running on premises. In some examples, VM spot manager 108a can maintain a list of VMs running on on-premises nodes 106a, along with an indication of what entity owns that VM instance. In such examples, VM spot manager 108a can identify whether any of these running VMs have an associated owner different from the customer that owns (or leases) customer system 110a. After operation 706, process flow 700 moves to operation 708.

Operation 708 depicts selecting a spot VM to terminate. This can comprise a VM running on on-premises nodes 106a that has an owner different from the customer that owns (or leases) customer system 110a. In some examples, various criteria can be used to select a VM to terminate, such as a VM that has been running for the longest amount of time, a VM that has been running for a shortest amount of time, and a VM that is consuming the most computing resources. After operation 708, process flow 700 moves to operation 710.

Operation 710 depicts terminating a spot VM. In some examples, this can cause VM spot manager 108a to indicate to the on-premises node that hosts this selected VM to terminate the VM immediately, rather than taking time to orderly shut the VM down. This can also include that on-premises node terminating that selected VM. After operation 710, process flow 700 moves to operation 712.

Operation 712 depicts reporting the action to the cloud spot manager In some examples, this comprises VM spot manager 108a sending a communication to cloud spot manager 102 an identification of which VM was terminated. This can also include other information, such as a time when the VM was terminated. After operation 712, process flow 700 moves to 714, where process flow 700 ends.

FIG. 8 illustrates an example process flow 800 for deploying a customer VM remotely where a customer has exhausted local resources to facilitate optimizing hybrid cloud usage, in accordance with certain embodiments of this disclosure. In some examples, aspects of process flow 800 can be implemented by VM spot manager 108a or VM spot manager 108b of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with aspects of one or more of process flow 300 of FIG. 3, process flow 400 of FIG. 4, process flow 500 of FIG. 5, process flow 700 of FIG. 7, process flow 900 of FIG. 9, and process flow 1000 of FIG. 10.

Process flow 800 begins with 802, and moves to operation 804. Operation 804 depicts determining more resources are needed. In some examples, operation 804 can be implemented in a similar manner as operation 704 of FIG. 7. After operation 804, process flow 800 moves to operation 806.

Operation 806 depicts determining that not enough resources are available on premises. This can comprise a VM spot manager (e.g., VM spot manager 108a of FIG. 1) determining that there are not any spot instances that can be terminated to free up sufficient resources for the new task. After operation 806, process flow 800 moves to operation 808.

Operation 808 depicts requesting the cloud spot manager to deploy the spot instance. This can comprise a VM spot manager requesting that the cloud spot manager deploy a particular spot instance, where the cloud spot manager will determine the customer system where the instance is to be deployed. In some examples, the VM spot manager can send the cloud spot manager a stored image of the instance, which can be deployed to an on-premises node and then executed without further configuration. After operation 808, process flow 800 moves to 810, where process flow 800 ends.

FIG. 9 illustrates an example process flow 900 for determining client billing to facilitate optimizing hybrid cloud usage, in accordance with certain embodiments of this disclosure. In some examples, aspects of process flow 900 can be implemented by cloud spot manager 102 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with aspects of one or more of process flow 300 of FIG. 3, process flow 400 of FIG. 4, process flow 500 of FIG. 5, process flow 700 of FIG. 7, process flow 800 of FIG. 8, and process flow 1000 of FIG. 10.

Process flow 900 begins with 902, and moves to operation 904. Operation 904 depicts determining a charge for on-premises nodes. A customer can lease some of its on-premises nodes (e.g., nodes of on-premises nodes 106a of FIG. 1). This lease can involve a set charge for a set period of time, and a stored indication of this lease arrangement can by maintained by cloud spot manager 102, which can access this in implementing operation 904. After operation 904, process flow 900 moves to operation 906.

Operation 906 depicts determining a credit for other spot VMs running on on-premises nodes. That is, where a customer's hardware has hosted other entity's spot VMs, the customer can be credited for that hosting. The amount of the credit can be based on factors such as a number of other entity's spot VMs, a time that these spot VMs executed for, and a configuration of these spot VMs (e.g., an amount of memory used for these spot VMs). After operation 906, process flow 900 moves to operation 908.

Operation 908 depicts determining a charge for spot VMs running in cloud. This determination can be similar to the determination of operation 906, but with the customer-in-question's spot VMs running elsewhere (as opposed to other entity's VMs running on the customer's hardware in operation 906). After operation 908, process flow 900 moves to operation 910.

Operation 910 depicts determining a total billing. This billing can be the sum of the charge determined in operation 904 and the charge determined in operation 908, reduced by the credit determined in operation 908. In some examples, this charge can then be applied to a customer account, or a record of it can be stored in a computer memory. After operation 910, process flow 900 moves to 912, where process flow 900 ends.

FIG. 10 illustrates an example process flow 1000 to facilitate optimizing hybrid cloud usage, in accordance with certain embodiments of this disclosure. In some examples, aspects of process flow 1000 can be implemented by cloud spot manager 102 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with aspects of one or more of process flow 300 of FIG. 3, process flow 400 of FIG. 4, process flow 500 of FIG. 5, process flow 700 of FIG. 7, process flow 800 of FIG. 8, and process flow 900 of FIG. 9.

Process flow 1000 begins with 1002, and moves to operation 1004. Operation 1004 depicts receiving a request to deploy a VM. In some examples, operation 1004 can be implemented in a similar manner as operation 304 of FIG. 3.

In some examples, some or all of operations 1004-1012 can be implemented by a cloud spot manager (e.g., cloud spot manager 102 of FIG. 1) that coordinates among multiple VM spot managers (e.g., VM spot manager 108a or VM spot manager 108b). This can be expressed as performing the receiving, the analyzing, the selecting, and the deploying comprises performing the receiving, the analyzing, the selecting, and the deploying by a device that is separate from a first node deployment and from a second node deployment.

In some examples, operation 1004 comprises receiving a request to deploy the virtual machine in response to a third device that prioritizes usage by the third user lacking computing resources to host the virtual machine. That is, a customer can request that a spot VM be deployed because that customer lacks available computing resources on its own hardware to host the VM.

Operation 1006 depicts analyzing first resource usage of a first node deployment that prioritizes usage for a first user identity, and of a second node deployment that prioritizes usage for a second user identity, the virtual machine being associated with a third user identity. In some examples, operation 1006 can be implemented in a similar manner as process flow 500 of FIG. 5, which generally depicts forecasting resource usage of customer systems.

In some examples, operation 1006 comprises receiving information about the first resource usage of the first node deployment from the first node deployment. That is, a cloud spot manager can receive resource usage information from VM spot managers.

In some examples, operation 1006 comprises determining time series data based on the first resource usage of the first node deployment. That is, a cloud spot manager can determine time series data for resource usage.

In some examples, operation 1006 comprises determining multivariate time series data based on the first resource usage of the first node deployment. That is, time series data can be multivariate time series data.

In some examples, operation 1006 comprises determining a resource load score based on the multivariate time series data. In some examples, the resource load score represents one value at a given point in time for the multivariate time series data. That is, multivariate time series data can be transformed into one resource load score for a given time.

In some examples, the resource load score represents a maximum value among a group of values for the multivariate time series data. That is, where the multivariate time series data comprises a plurality of values for a given point of time, the resource load score for that point in time can be determined to be the maximum value among the plurality of values in the multivariate time series at that point in time.

In some examples, the resource load score represents a weighted sum of a group of values for the multivariate time series data. That is, a resource load score at a given point of time can comprise a weighted sum of the plurality of values in the multivariate time series at that point in time.

In some examples, operation 1006 can be expressed as, analyzing first resource usage of a first node deployment that prioritizes usage in association with a first user identity, and of a second node deployment that prioritizes usage in association with a second user identity.

In some examples, operation 1006 comprises predicting future resource usage of the first node deployment, resulting in predicted future resource usage of the first node deployment, and wherein performing the selecting of the first node deployment comprises selecting the first node deployment based on the predicted future resource usage.

In some examples, the first node deployment comprises a first node on which the virtual machine is deployable and a second node, owned by a first user associated with the first user identity, that is unavailable to the virtual machine for deployment. That is, a customer's hardware deployment can comprise both nodes that are controlled by a cloud spot manager, and customer-managed nodes.

In some examples, operation 1006 can be expressed as analyzing a first load of a first device that prioritizes usage by a first user, and a second load of a second device that prioritizes usage by a second user.

In some examples, a management device has read access as part of a first resource pool that comprises the first device, wherein the management device has an administrator role as part of a second resource pool that comprises a third device, and wherein the third device is owned by the first user that is unavailable to the virtual machine for deployment. That is, a VM spot manager can have read access for nodes that only the customer's own instances can be deployed, and an administrator role for nodes on which other customer spot instances can be deployed.

Operation 1008 depicts selecting the first node deployment for the virtual machine based on the first resource usage of the first node deployment and second resource usage of the second node deployment. In some examples, operation 1008 can be implemented in a similar manner as operation 512 of FIG. 5.

In some examples, operation 1008 can be expressed as, selecting the first node deployment for a virtual machine associated with a third user identity based on the first resource usage of the first node deployment and second resource usage of the second node deployment.

In some examples, operation 1008 can be expressed as selecting the first device for a virtual machine being associated with a third user based on the first load of the first device and the second load of the second device.

Operation 1010 depicts deploying the virtual machine to the first node deployment. In some examples, operation 1010 can be implemented in a similar manner as operation 310 of FIG. 3.

In some examples, operation 1010 can include billing functions. In some examples, operation 1010 comprises determining a billing applicable to the first user identity based on a charge for the first node deployment and a credit for the virtual machine being deployed to the first node deployment. That is, a given customer's bill can be a lease for hardware, along with a credit for other entity's spot VMs run on that hardware.

In some examples, operation 1010 comprises determining the billing based on a charge for a second virtual machine associated with the first user identity being deployed to a location other than the first node deployment. That is, the customer can also be billed based on a charge for its spot VMs being run on other entities' hardware.

In some examples, operation 1010 comprises determining the billing based on a credit for network bandwidth associated with the first user identity that is utilized in association with deploying the virtual machine. That is, the customer can also be billed based on a credit for its bandwidth being used to administer spot VMs.

In some examples, operation 1010 can be expressed as deploying the virtual machine to the first device.

Operation 1012 depicts terminating the virtual machine on the first node deployment based on re-allocating resources associated with the virtual machine to a task associated with the first user identity.

In some examples, operation 1012 comprises receiving the indication that the first node deployment terminated the first virtual machine or a second virtual machine associated with a user identity other than the first user identity, the first node deployment having re-allocated resources associated with the first virtual machine or the second virtual machine to a task associated with the first user identity. That is, a spot VM can be terminated instantly so that the customer who leases or owns the hardware can use more computing resources on that hardware.

In some examples, operation 1012 comprises terminating the virtual machine without permitting an operating system of the virtual machine to shut down.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, aspects of computing environment 1100 can be used to implement aspects of cloud spot manager 102, customer system 110a, and/or customer system 110b of FIG. 1, and/or customer system 210a of FIG. 2. In some examples, computing environment 1100 can implement aspects of the process flows of FIGS. 3-5 and/or 7-10 to facilitate optimizing hybrid cloud usage.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example computing environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in computing environment 1100, a solid state drive (SSD) could be used in addition to, or in place of, an internal HDD 1114. The internal HDD 1114, external storage device(s) 1116 and optical disk drive 1120 can be connected to the system bus 1108 by an HDD interface 1124, an external storage interface 1126 and an optical drive interface 1128, respectively. The HDD interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for application programs 1132. Runtime environments are consistent execution environments that allow application programs 1132 to run on any operating system that includes the runtime environment. Similarly, operating system 1130 can support containers, and application programs 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the LAN 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving a request to deploy a virtual machine;
analyzing first resource usage of a first node deployment that prioritizes usage for a first user identity, and of a second node deployment that prioritizes usage for a second user identity, the virtual machine being associated with a third user identity;
selecting the first node deployment for the virtual machine based on the first resource usage of the first node deployment and second resource usage of the second node deployment;
deploying the virtual machine to the first node deployment; and
terminating the virtual machine on the first node deployment based on re-allocating resources associated with the virtual machine to a task associated with the first user identity.

2. The system of claim 1, wherein performing the receiving, the analyzing, the selecting, and the deploying comprises performing the receiving, the analyzing, the selecting, and the deploying by a device that is separate from the first node deployment and from the second node deployment.

3. The system of claim 1, wherein performing the analyzing of the first resource usage comprises:
receiving information about the first resource usage of the first node deployment from the first node deployment.

4. The system of claim 3, wherein performing the analyzing of the first resource usage comprises:
determining time series data based on the first resource usage of the first node deployment.

5. The system of claim 3, wherein performing the analyzing of the first resource usage comprises:
determining multivariate time series data based on the first resource usage of the first node deployment.

6. The system of claim 5, wherein performing the analyzing of the first resource usage comprises:
determining a resource load score based on the multivariate time series data.

7. The system of claim 6, wherein the resource load score represents one value at a given point in time for the multivariate time series data.

8. The system of claim 7, wherein the resource load score represents a maximum value among a group of values for the multivariate time series data.

9. The system of claim 7, wherein the resource load score represents a weighted sum of a group of values for the multivariate time series data.

10. A method comprising:
analyzing, by a system comprising a processor, first resource usage of a first node deployment that prioritizes usage in association with a first user identity, and of a second node deployment that prioritizes usage in association with a second user identity;
selecting, by the system, the first node deployment for a virtual machine associated with a third user identity based on the first resource usage of the first node deployment and second resource usage of the second node deployment; and
deploying, by the system, the virtual machine to the first node deployment.

11. The method of claim 10, wherein performing the analyzing of the first resource usage of the first node deployment comprises predicting future resource usage of the first node deployment, resulting in predicted future resource usage of the first node deployment, and wherein performing the selecting of the first node deployment comprises selecting the first node deployment based on the predicted future resource usage.

12. The method of claim 10, further comprising:
determining, by the system, a billing applicable to the first user identity based on a charge for the first node deployment and a credit for the virtual machine being deployed to the first node deployment.

13. The method of claim 12, wherein the virtual machine is a first virtual machine, and wherein performing the determining of the billing applicable to the first user identity comprises:
determining the billing based on a charge for a second virtual machine associated with the first user identity being deployed to a location other than the first node deployment.

14. The method of claim 12, wherein performing the determining of the billing applicable to the first user identity comprises:
determining the billing based on a credit for network bandwidth associated with the first user identity that is utilized in association with deploying the virtual machine.

15. The method of claim 10, wherein the virtual machine is a first virtual machine, and further comprising:
receiving an indication that the first node deployment terminated the first virtual machine or a second virtual machine associated with a user identity other than the first user identity, the first node deployment having re-allocated resources associated with the first virtual machine or the second virtual machine to a task associated with the first user identity.

16. The method of claim 10, wherein the first node deployment comprises a first node on which the virtual machine is deployable and a second node, owned by a first user associated with the first user identity, that is unavailable to the virtual machine for deployment.

17. A non-transitory computer-readable medium comprising instructions that, in response to execution, cause a system comprising a processor to perform operations, comprising:
analyzing a first load of a first device that prioritizes usage by a first user, and a second load of a second device that prioritizes usage by a second user;
selecting the first device for a virtual machine being associated with a third user based on the first load of the first device and the second load of the second device; and
deploying the virtual machine to the first device.

18. The non-transitory computer-readable medium of claim 17, wherein the operations further comprise:
receiving a request to deploy the virtual machine in response to a third device that prioritizes usage by the third user lacking computing resources to host the virtual machine.

19. The non-transitory computer-readable medium of claim 17, wherein the operations further comprise:
terminating the virtual machine without permitting an operating system of the virtual machine to shut down.

20. The non-transitory computer-readable medium of claim 17, wherein a management device has read access as part of a first resource pool that comprises the first device, wherein the management device has an administrator role as part of a second resource pool that comprises a third device, and wherein the third device is owned by the first user that is unavailable to the virtual machine for deployment.
